(19) United States
(12) Patent Application Publication
(10) Pub. No.: US 2018/0341942 A1
(43) Pub. Date: Nov. 29, 2018

(54) Secure RFID Tag Association with a User

(71) Applicant: Motorola Mobility LLC, Chicago, IL (US)

(72) Inventors: Scott Patrick DeBates, Crystal Lake, IL (US); Douglas Alfred Lautner, Round Lake, IL (US)

(73) Assignee: Motorola Mobility LLC, Chicago, IL (US)

(21) Appl. No.: 15/602,898

(22) Filed: May 23, 2017

(51) Int. Cl. G06Q 20/32; G06K 19/077; G06K 7/10; G06Q 20/40; G06F 3/0484

(52) U.S. Cl. CPC G06Q 20/3278; G06K 19/07758; G06K 7/10366; G06F 21/6245; G06F 3/0484; G06Q 20/3255; G06Q 20/4014

(57) ABSTRACT

Various embodiments provide an ability to associate an RFID tag with a user. Some embodiments associate am RFID tag to an item by storing information associated with the item on the RFID tag and/or attaching the RFID tag to the item. When an RFID reader extracts data from the RFID tag, the RFID reader, or a device communicatively coupled to the RFID reader, requests validation information from a backend server. Upon receiving the validation information, the device or RFID reader restricts access to the RFID tag by locking access to stored data based on the validation information. The device or RFID reader then associates the RFID tag with a user by forwarding the validation information to the user. Some embodiments use the validation information to create trusted access to the RFID tag with a particular RFID reader and/or device.

### BACKGROUND

Retail items, such as portable devices, electronic devices, clothing, and other types of consumer goods can use a Radio Frequency IDentification (RFID) tag to store information. In turn, an RFID reader can be used to access this information. Once the user purchases a retail item that includes an RFID tag, the user may no longer want others to have access to the information stored on the RFID tag. Thus, while the RFID tag provides the ability to store useful information, the open nature of obtaining the information may adversely impact a user's desire to have more direct control over who has access to an RFID tag once the user possesses the associated item.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates an overview of a representative environment that includes an example implementation in accordance with one or more embodiments;

FIG. 2 illustrates an example environment in which an RFID tag interacts with an RFID reader;

FIGS. 3a and 3b illustrate an example method of associating an RFID tag with a user in accordance with one or more embodiments; and

FIG. 4 illustrates various components of an example device that can implement embodiments of associating an RFID tag with a user.

### DETAILED DESCRIPTION

The following description is based on embodiments of the claims and should not be taken as limiting the claims with regard to alternative embodiments that are not explicitly described herein.

Various embodiments provide an ability to associate an RFID tag with a user. Some embodiments associate an RFID tag to an item by storing information associated with the item on the RFID tag and/or attaching the RFID tag to the item. When an RFID reader extracts data from the RFID tag, the RFID reader, or a device communicatively coupled to the RFID reader, can request validation information from a backend server. Among other things, the validation information provides data that can be used to authentication or validate an access request associated with information stored on an RFID tag. Upon receiving the validation information, the device or RFID reader can restrict access to the RFID tag by sending commands to the RFID tag that lock access to the stored information. The device or RFID reader can then associate the RFID tag with a user by transferring the validation information from the device to the user and/or an associated user account. Some embodiments use the validation information to establish trusted access to the RFID tag using a particular RFID reader and/or device. For instance, once a particular RFID reader provides the validation information to the RFID tag and is authorized to access the RFID tag, some embodiments recognize the RFID reader as a trusted device that no longer needs to provide validation information to gain access to the RFID tag.

Consider now an example environment in which various aspects as described herein can be employed.

Example Environment

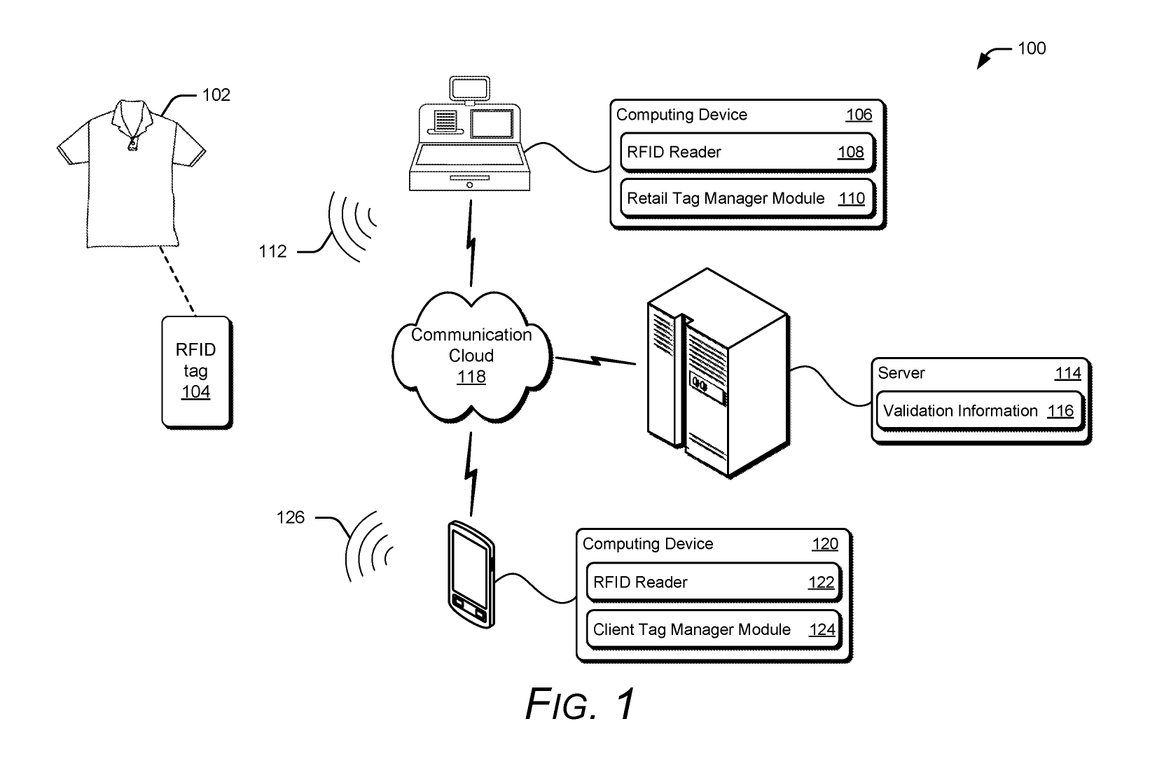

FIG. 1 illustrates an example operating environment 100 in accordance with one or more embodiments. Environment 100 includes item 102 in the form of a shirt. However, item 102 can be any other suitable type of item such as a computing device, a different article of clothing, a book, a plant, a food item, media, an appliance, and so forth. Here, item 102 has an RFID tag 104 mounted on or attached to it that includes information pertaining to item 102, as described below in more detail.

RFID tag 104 is a small, programmable electronic tag or “label” that stores identifying data or other information as further described herein. RFID tag 104 can include various components and features that are utilized for one-way or two-way wireless communication with an RFID reader, as further described herein. In some cases, RFID tag 104 is activated or powered-up when in the presence of, or within range of, the RFID reader. Thus, RFID tag 104 can assume an activated state or an un-activated state. In the activated state, the RFID tag 104 is operational and can perform operations including collecting data, receiving transmitted data, and/or transmitting data. In the un-activated state, the RFID tag 104 is less or differently operational than when in the activated state, or is not operational at all. RFID tag 104 can include any suitable type of information, such as washing instructions, drying instructions, a serial number, an Internet address to a backend server, manufacturing data (e.g., lot number, manufacturer ID, origination location, current location, intended destination), inventory information, user specific information, and so forth.

In environment 100, RFID tag 104 is considered to be within working range of computing device 106, illustrated here in the form of a cash register. However, computing device 106 can be any other suitable type of device, such as a tablet, a laptop, a desktop computer, and so forth. Among other things, computing device 106 includes an RFID reader 108 and retail tag manager module 110. The phrase “within working range” indicates that RFID tag 104 has moved within range of computing device 106 such that RFID reader 108 can successfully identify, activate, and/or extract information from RFID tag 104. While computing device 106 is illustrated here as including RFID reader 108, other embodiments include RFID reader as an auxiliary device and/or a device that is communicatively coupled to computing device 106 in order to exchange information.

RFID reader 108 represents functionality to extract information from an RFID tag. In some embodiments, RFID reader 108 transmits an interrogation signal as a broadcast message requesting RFID tags that are in range to return the identifying data or information that the RFID tags have stored, such as through the use of radio frequency (RF) communication signals 112. Since RFID tag 104 is considered to be within working range of RFID reader 108, RFID tag 104 wirelessly communicates stored information to the RFID reader 108 via an RF communication channel. At some point during the purchase transaction, RFID reader 108 transmits communication signals 112 to excite and/or extract information from RFID tag 104. This can be automatically initiated by computing device 106, can be initiated by a user initiating the scanning process, and/or can be a polling process performed by RFID reader 108 to identify when any RFID tags are in close enough range to successfully extract information and/or data.

Retail tag manager module 110 represents retailer-side functionality that manages an RFID tag, such as tag configuration, transfer of tag ownership, and so forth. For example, upon extracting information from RFID tag 104, RFID reader 108 may pass some or all of the information to retail tag manager module 110 for interpretation and/or further processing. In turn, such as during a purchase transaction, some embodiments of retail tag manager module 110 transmit a request to server 114 for validation information 116 to lock RFID tag 104 as further described herein. The request can be transmitted in any suitable manner, and over any suitable communication network. Here, the request is transmitted from retail tag manager module 110 (by way of computing device 106) to server 114 over communication cloud 118. Some embodiments of retail tag manager module 110 use information extracted from RFID tag 104 to transmit the request. For example, server 114 can be a backend server affiliated with, or commissioned by, a company that manufacturers item 102 and/or RFID tag 104. Thus, as part of the manufacturing process, or post-manufacturing process, address information pertaining to server 114 may be stored on RFID tag 104 (e.g., an email address, a HyperText Transfer Protocol (HTTP) address, an Internet protocol (IP) address, etc). In turn, retail tag manager module 110 uses this information to know how and/or from where to request the validation information. Retail tag manager module 110 can also interface with RFID reader 108 to transmit commands to RFID tag 104, such as a “lock” command, and/or transfer ownership of RFID tag 104 to another user, such as by transmitting the validation information over communication cloud 118 to a user account. Thus, retail tag manager module 110 represents functionality at computing device 106 that manages an RFID tag.

Server 114 includes validation information 116, which can either be generated by server 114, or obtained from a third party. Some embodiments of server 114 request validation information from a third-party vendor or computing device. Other embodiments of server 114 generate validation information internally. Validation information 116 represents any type information or object that can be used to validate a command or access request, such as a passcode, a password, a public and/or private key, and so forth. Accordingly, upon receiving a request from retail tag manager module 110, server 114 forwards validation information 11 to retail tag manager module over communication cloud 118.

Communication cloud 118 generally represents any suitable type of communication network that facilitates uni-directional and/or bi-directional communications with various computing devices. Communication cloud 118 can include multiple interconnected communication networks that comprise a plurality of interconnected elements, such as a wireless local area network (WLAN) with Ethernet access, a wireless telecommunication network interconnected with the Internet, a wireless (Wi-Fi) access point connected to the Internet, and so forth. In this example, communication cloud 118 can be used by computing device 106, server 114, and/or computing device 120 to exchange information in any suitable manner.

Computing device 120, illustrated here as a mobile phone, represents a user device. However, computing device 120 can have alternate forms, such as a tablet, a laptop, a desktop computer, and so forth. Among other things, computing device 120 has access to, or is associated with, various user accounts, such as an electronic mail (email) account, a mobile phone number, an instant messaging account, and so forth. To access a user account, computing device 120 communicates with other computing devices over communication cloud 118, such as an email server, a cellular network, etc. In some embodiments, computing device 120 receives validation information from retail tag manager module 110, such as by receiving a Short Message Service (SMS) text message that includes the validation information or accessing an email. Among other things, computing device 120 includes RFID reader 122 and client tag manager module 124.

As in the case of RFID reader 108, RFID reader 122 represents functionality that extracts information from an RFID tag using communication signals 126. For simplicity's sake, RFID reader 122 is illustrated here as a component of computing device 120, but it is to be appreciated that it can alternately or additionally be an auxiliary device of computing device 120, or an RFID reader that is communicatively coupled to computing device 120.

Client tag manager module 124 represents functionality that manages client-side access to an RFID tag, such as access to RFID tag 104, and/or RFID tag configuration. For example, some embodiments of client tag manager module 124 receive and/or retrieve validation information 116 from retail tag manager module 110 and/or server 114. In turn, client tag manager module 124 uses some or all of validation information 116 to gain access to RFID tag 104 after it has been locked by retail tag manager module 110. Alternately or additionally, client tag manager module 124 can gate access to RFID tag 104, send commands to erase stored information, send commands to update stored information, and so forth. To manage access to RFID tag 104, client tag manager module 124 interfaces with RFID reader 122. While this example illustrates client tag manager module 124 and RFID reader 122 as separate entities, some embodiments implement client tag manager module 124 as an entity that resides within RFID reader 122 or vice versa. Some embodiments of client tag manager module 124 provide a user interface to enable a user to manage and/or configure the information stored on RFID tag 104. The user interface of client tag manager module 124 can include interactive controls that allow the user to initiate commands to RFID tag 104 and/or retrieve information stored on RFID tag 104 by way of communication signals 126. As in the case of communication signals 112, communication signals 126 represent any suitable form of wireless communication used by RFID reader 122 to exchange information with RFID tag.

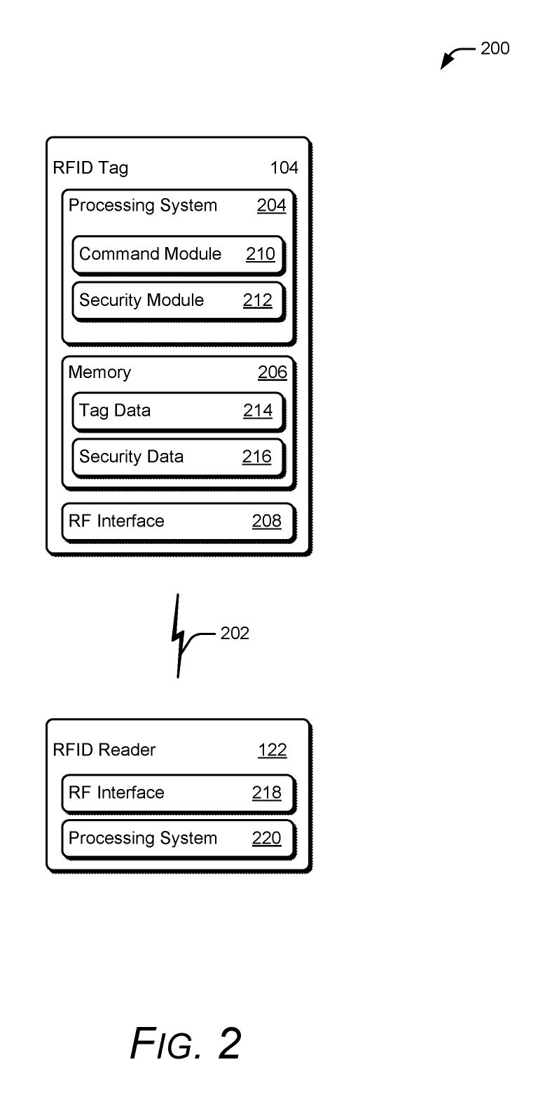

FIG. 2 illustrates an example system 200 that includes RFID tag 104 and RFID reader 122 of FIG. 1 in more detail. While FIG. 2 illustrates RFID reader 122 of FIG. 1, it is to be appreciated that various aspects described with respect to RFID reader 122 can alternately or additionally be applied to RFID reader 108 of FIG. 1. To access the data and other information, the RFID reader 122 transmits an interrogation signal (illustrated here as communication signals 202) as a broadcast message requesting RFID tags that are in range to return the data and/or stored information. The RFID tags then wirelessly communicate the data and information to the RFID reader via a radio frequency (RF) communication channel (e.g., communication signals 202), which the RFID reader 122 then receives as information. Accordingly, RFID reader 122 interacts with RFID tag 104 via communication signals 202 to exchange information that can be subsequently used to associate the RFID tag with a user. As in the case of communication signals 112 and communication signals 126 of FIG. 1, communication signals 202 represent any suitable type of RF signal that can be used to communicated data and/or information.

RFID tag 104 includes various components, such as such as a processing system 204, a memory 206, and an RF interface 208. However, other components and/or hardware can be included without departing from the scope of the claimed subject matter. Further, RFID tag 104 can be an active RFID tag or a passive RFID tag. Active RFID tags are powered by an internal battery, which is used to power the various internal components. Passive RFID tags, on the other hand, have no internal power source. Rather, passive RFID tags are powered by electromagnetic energy transmitted from an RFID reader. In these instances, RFID tag 104 can include one or more capacitors (not illustrated here) to hold a charge that is used to power the various components.

Processing system 204 represents functionality that performs procedures and/or operations in response to input. Processing system 204 can include any combination of hardware, firmware, and/or software that is configured to respond to input commands and/or achieve a desired result. For example, processing system 204 can include a central processing unit (CPU) configured to execute computer-readable processor instructions stored on memory 206, Field Programmable Gate Arrays (FPGAs), Application-Specific Integrated Circuits (ASICs), and so forth. In this example, processing system 204 includes command module 210 and security module 212.

Command module 210 represents functionality that receives an input command, such as commands received through RF interface 208, and processes the input command to determine and/or perform a corresponding response. Alternately or additionally, command module 210 manages a corresponding state of RFID tag 104 (e.g., active, silent, asleep, awake, killed, etc.). Any type of command can be processed by command module, such as a store command to store data and/or authentication information on the RFID tag, a retrieve command to retrieve information stored on the RFID tag, a kill command to permanently disable access to the RFID tag such that the RFID tag is no longer reusable, and so forth. In some embodiments, a command message or packet received by command module 210 has sufficient bits or bytes to include authentication information, such as a password or passcode. The command message can be received in one data packet, or multiple data packets.

In some embodiments, command module 210 works in concert with security module 212 to verify and authenticate commands and/or data received from RFID reader 122, to associate RFID tag 104 with a particular user, and/or to provide secure access to information stored internally to RFID tag 104. Such information that can include, by way of example and not limitation, user information associated with a particular user, product information associated with a particular product, authentication information, and the like. While not illustrated here, when implemented as a software application, command module 210 can be stored on computer-readable storage memory (e.g., memory 206), such as any suitable memory device or electronic data storage implemented in RFID tag 104.

Security module 212 represents functionality that safeguards access to information stored on RFID tag 104. For instance, consider an example in which command module 210 receives a request command for information stored on memory 206. In turn, command module 210 may first consult with security module 212 to determine if the request has the authentication to access the information. For example, when command module 210 receives a command from RFID reader 122, the command may include an access password. In turn, command module 210 passes the command and/or access password to security module 212 in order to verify whether the received access password included with the command is sufficient to access data stored in memory 206. If security module 212 validates the access password included with the command has proper authentication (e.g., the received access password matches or is the same as the access password in memory 206), then security module 212 informs command module 210 that the command is valid, and to proceed with processing the command. Conversely, if the security module cannot verify or validate the received access password, then the command module 210 is notified to not process the command. As another example, security module 212 may validate whether the command has originated from a trusted device (e.g., a device with known or valid credentials). Thus, security module 212 provides authentication functionality to command module 210. While not illustrated here, when implemented as a software application, security module 212 can be stored on memory 206.

Memory 206 represents any suitable type of computer-readable memory device any suitable memory device that enables data storage and/or provides persistent storage of data and executable instructions. A computer-readable memory device can include, by way of example and not of limitation, various implementations of random access memory (RAM), read only memory (ROM), flash memory, and other types of storage media in various memory device configurations. Here, memory 206 includes tag data 214 and security data 216.

Tag data 214 represents any suitable type of data associated with RFID tag 104. In some embodiments, portions of tag data 214 include product and/or manufacturing information, such as product composition, product cleaning instructions, Stock Keeping Unit (SKU) information, a serial number, an electronic product code (EPC), product manufacturing date, product manufacturing location, manufacturing contact information, and so forth. Portions of tag data 214 can also include data generated by command module 210, such as tag state information managed by command module 210. In some embodiments, portions of tag data 214 include data received from RFID reader 122 via communication signals 202.

Security data 216 includes authentication information that can be used to gate access to tag data 214 and/or access to memory 206. In some embodiments, security data 216 includes all or portions of validation information 116 of FIG. 1. Alternately or additionally, security data 216 includes data used to validate trusted devices. To validate or authenticate access to RFID tag 104, security module 212 may use portions of security data 216 during the validation process as further described herein. The authentication information stored in security data 216 can be any suitable size and of any suitable data type, such as a password with a size of 32 bits, an authentication key with a size of 64 bits, a passcode of 16 bits, and so forth.

Among other things, RF interface 208 represents an ability to conduct wireless communications (e.g., protocol processes, modulating data, demodulating data, signal transmission, signal reception, and so forth). To facilitate unidirectional or bi-directional communications with RFID readers, RF interface 208 includes a transmitter and receiver (or transceiver). In some embodiments, command module 210 interfaces with and/or communicates with RF interface 208 to send and receive data. For example, in response to receiving an interrogation signal from RFID reader 122 via RF interface 208, command module 210 formulates a response that may include data from tag data 214, and then communicate with RF interface 208 to wirelessly transmit the response to RFID reader 122. The response signals from RF interface 208 can be communicated using low frequency (LF), high frequency (HF), or ultra-high frequency (UHF) radio waves.

As further described herein, RFID reader 122 transmits communication signals 202 to interact with RFID tag 104. Accordingly, similar to RF interface 208 of RFID tag 104, RFID reader 122 includes an RF interface 218. RF interface 218 can include any suitable combination of hardware, firmware, and/or software to generate and transmit wireless signals to RFID tag 104, as well as to receive and demodulate wireless signals received from RFID tag 104. This can include any suitable type of wireless signal with any suitable corresponding protocol.

Processing system 220 generally represents any combination of hardware, firmware, and/or software that is configured to control operation of RFID reader 122. For example, processing system 220 can include a CPU that executes computer-readable processor instructions stored on memory (not illustrated), Field Programmable Gate Arrays (FPGAs), Application-Specific Integrated Circuits (ASICs), and so forth. In some embodiments, processing system 220 provides interfaces for external devices and/or external modules to communicate with RFID reader 122, such as client tag manager module 124 and/or retail tag manager module 110 of FIG. 1. For example, client tag manager module 124 can communicate with processing system 220 to request information from RFID tag 104. After receiving the request from client tag manager module 124, processing system 220 interfaces with RF interface 218 to send the necessary commands to retrieve information. In turn, upon receiving the information from RFID tag 104, processing system 220 can forward the information to client tag manager module 124. Thus, processing system 220 can decipher various forms of input to RFID reader 122, and perform the appropriate functionality or response to the input.

Having described an example operating environment in which various embodiments can be utilized, consider now a discussion of associating an RFID tag with a user in accordance with one or more embodiments.

Associating an RFID Tag with a User

An RFID tag provides manufacturers, distributors, and retailers with a way to associated data with a particular product. For example, manufacturers can attach an RFID tag to a product and store information about the product and/or the manufacturing process on the RFID tag. Since the RFID tag is attached to the product, the information stored in the tag travels with the product, and enables the manufacturer to deliver information to an end user that purchases the product. Similarly, distributors and/or retailers can store inventory information on the RFID tag to track a product, or pricing information in order simplify a purchase transaction associated with the product. For many RFID tags, this information is available to the general public such that anyone with an RFID reader can access information stored on the RFID tag. While this information is a useful tool for manufacturers and retailers, a user who subsequently purchases the product may desire to have more control over this information in order to protect their privacy. In other words, instead of granting general access to the information on the RFID tag, a user may wish to restrict access to the RFID tag such that only the user can access the information. Thus, it is desirable to transition the RFID tag from being a general purpose and/or a generic tag (or being owned by the retailer), to having a user association that allows the user control over access to information stored on the RFID tag.

Various embodiments provide an ability to associate an RFID tag with a user. Some embodiments associate an RFID tag to an item for purchase by storing information about the item on the RFID tag and/or attaching the RFID tag to the item. When an RFID reader extracts data from the RFID tag, the RFID reader, or a device communicatively coupled to the RFID reader, can use the data to request validation information from a backend server, such as by extracting an address from the data to use in contacting the backend server. Upon receiving the validation information, the device or RFID reader restricts access to the RFID tag by locking access to the data. For instance, the RFID tag can be locked, with access only being granted to commands that include a portion or all of the validation information. In some embodiments, the RFID tag is then associated with a user by forwarding and/or transferring the validation information to the user and/or a corresponding user account.

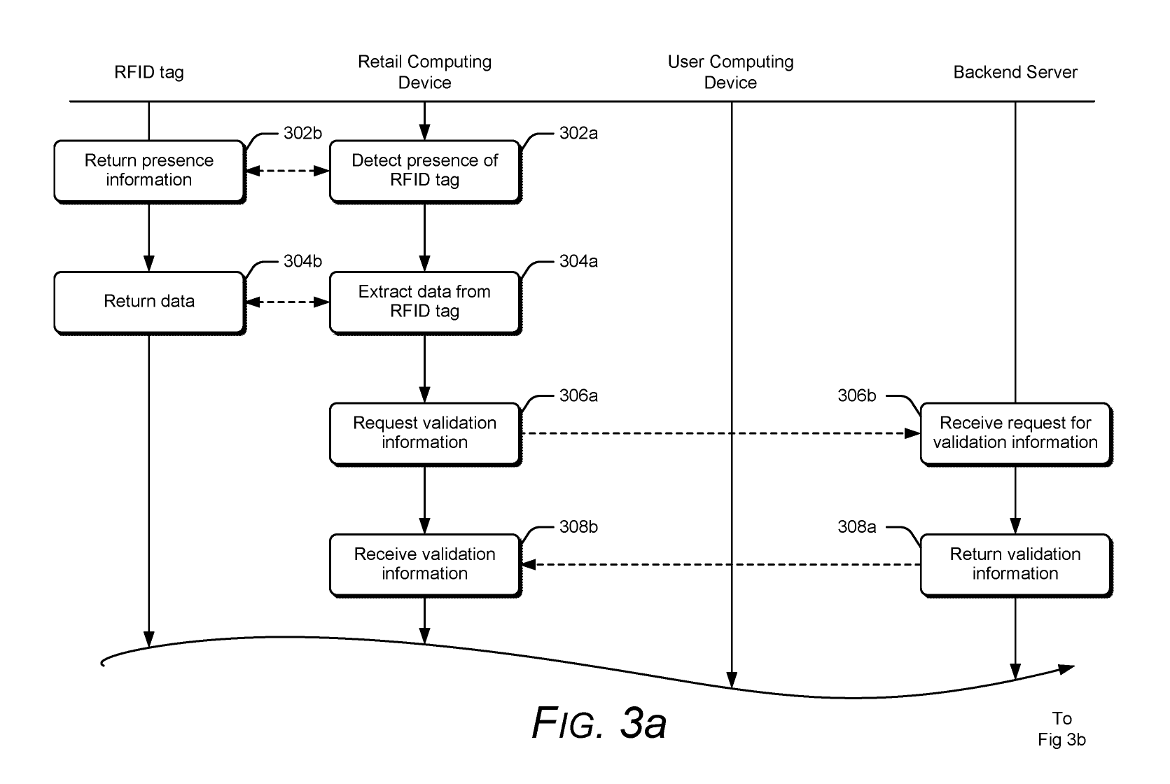

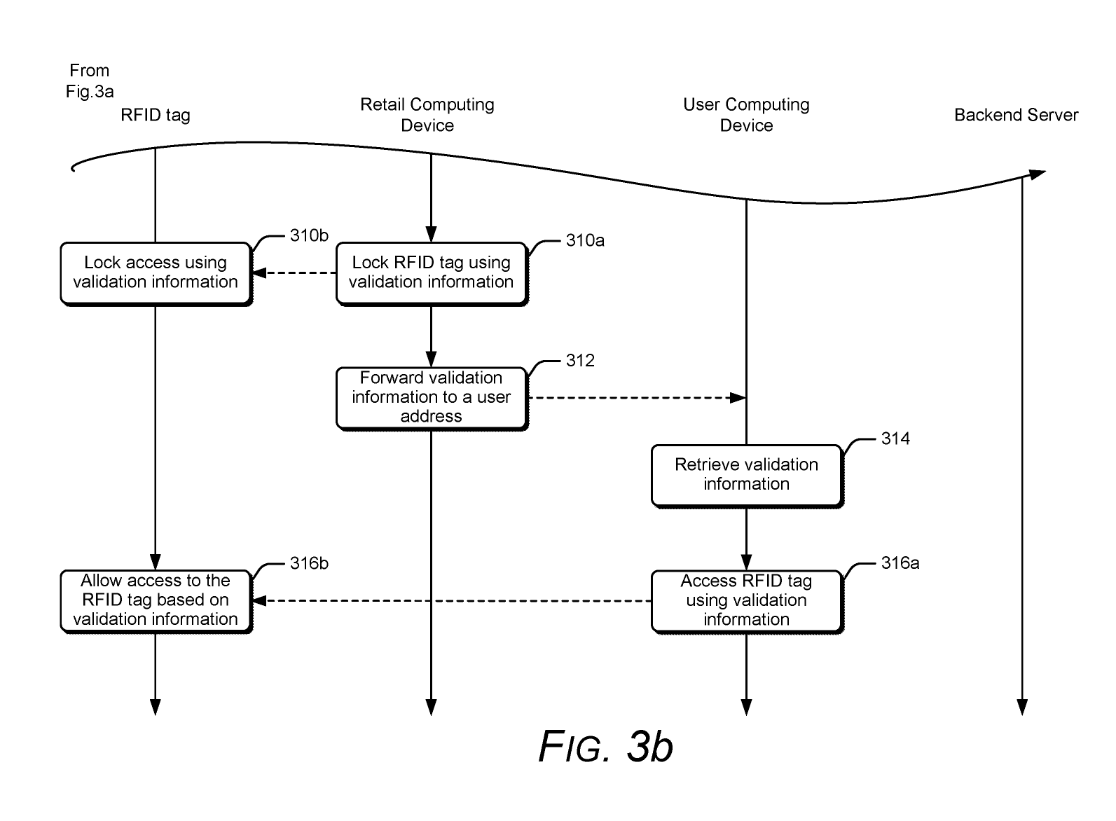

Consider now FIGS. 3a and 3b that together illustrate a method of associating an RFID tag with a user in accordance with one or more embodiments. The method can be performed by any suitable hardware, software, firmware, or combination thereof. In at least some embodiments, aspects of the method can be implemented by one or more suitably configured devices, such as RFID tag 104, computing device 106, computing device 120, and/or server 114 of FIG. 1. FIG. 3a illustrates a starting point into the method and continues on to FIG. 3b. While the method described in FIGS. 3a and 3b illustrates these steps in a particular order, it is to be appreciated that any specific order or hierarchy of the steps described here is used to illustrate an example of a sample approach. Other approaches may be used that rearrange the ordering of these steps. Thus, the order steps described here may be rearranged, and the illustrated ordering of these steps is not intended to be limiting.

FIGS. 3a and 3b illustrate the interactions between four entities: an RFID tag, a retailer computing device, a user computing device, and a backend server. In some embodiments, these devices are representative of RFID tag 104, computing device 106, computing device 120, and server 114 of FIG. 1, respectively. Each device has a respective timeline directly beneath it that illustrates various functionality provided by that device. Thus, the vertical line directly beneath the RFID tag corresponds to its respective functionality, the vertical line directly beneath the retail computing device corresponds to its respective functionality, the vertical line directly beneath the user computing device corresponds to its respective functionality, and the vertical line beneath the backend server corresponds to its respective functionality. In some cases, two devices share a same designator number that is differentiated by a letter (e.g. XXXa versus XXXb). In these instances, the shared designator number indicates a relationship between the corresponding functionality and/or devices, such as a message exchange between devices.

At step 302a, the retail computing device, by way of an RFID reader, detects the presence of an RFID tag. For example, the retail computing device can include an RFID reader and/or be communicatively coupled with an RFID reader as illustrated by computing device 106 and RFID reader 108 of FIG. 1. In turn, the corresponding RFID reader periodically or continuously scans for RFID tags that are within working range of the RFID reader by sending interrogation or broadcast signals. Consider a case in which a user wanders around a retail store shopping for products to purchase. For this particular retail store, each product has a respective RFID tag attached to it. After a user selects a product to purchase, and is ready to complete a purchase transaction, the user walks towards a checkout register (which represents the retail computing device). In turn, since the RFID tag is attached to the product, the RFID tag moves within working range of the corresponding RFID reader of the checkout register. Accordingly, the RFID tag receives interrogation or broadcast signals send by the RFID reader, and returns presence information to the RFID reader at step 302b. Thus, in this manner, the RFID reader detects the presence of the RFID tag. In some embodiments, after detecting the RFID tag, the RFID reader sends the checkout register a notification about the detected RFID tag, such as by sending a notification or event to retail tag manager module 110. In turn, some embodiments of the retail computing device display a user interface (by way of retail tag manager module 110) that notifies the retailer that an RFID tag has been successfully detected.

Responsive to detecting the presence of an RFID tag, the retail computing device, by way of the corresponding RFID reader, extracts data from the RFID tag at step 304a. For instance, the RFID reader can send a query command for tag data stored locally on the RFID tag, such as tag data 214 of FIG. 2. As further described here, the query command can be send over a wireless communication link. In turn, the RFID tag receives and processes the query command, such as through the use of RF interface 208 and/or command module 210 of FIG. 2, and returns the requested data at step 304b. As in the case of the RFID reader, the RFID tag can wirelessly transmit the information using RF interface 208 to generate and transmit the wireless communication signals.

When a user commits to purchasing a product, ownership of the product transfers from the retailer to the user. As part of the purchase transaction, the retailer may desire change the accessibility of RFID tag from being open and/or general to private. Thus, at step 306a, the retail computing device requests validation information from a backend server associated with the product. This can be achieved in any suitable manner, such as through an interactive control on the user interface of the retail tag manager module, or automatically as part of a purchase transaction (e.g., upon transfer of payment). The request can include any suitable type of information, such as serial number information, EPC numbers, manufacturing data information, or any other suitable type of information. Accordingly, the retail computing device may use data extracted from the RFID tag to generate the request for validation information. In some embodiments, the retail computing device uses a communication address extracted from the RFID tag to contact the backend server. Alternately or additionally, the retail computing device can use product or manufacturing information extracted from the RFID tag. The request can be sent to the backend server in any suitable manner, such as those described with respect to communication cloud 118 of FIG. 1. In turn, at step 306b, the backend server receives the request for validation information.

Responsive to receiving the request for validation information, the backend server returns validation information to the retail computing device at step 308a. In some instances, the backend server generates unique validation information for the corresponding RFID tag using information included in the request from the retail computing device. Alternately or additionally, the backend server generates random validation information, or requests validation information from a third party. Thus, the validation information can be generated by the backend server in any suitable manner, or be obtained from a third party. Accordingly, at step 308b, the retail computing device receives the validation information. This can be received over any suitable communication path, examples of which are provided herein. In some embodiments, the retail computing device displays the validation information on a user interface and/or displays a notification that the validation information has been received by way of retail tag manager module 110 of FIG. 1.

Continuing on, the method now advances to FIG. 3b. At step 310a, the retail computing device, by way of an RFID reader, locks the RFID tag using the validation information. For example, the retail computing device (by way of retail tag manager module 110) can display a user interface with an interactive control that initiates a “lock” command. When the control is activated, the retail computing device, by way of the RFID reader, sends the lock command over a wireless communication channel. In other embodiments, the retail computing device may initiate the lock command automatically upon receiving the validation information from the backend server. The lock command can include some or all of the validation information. In turn, at step 310b, the RFID tag locks access to information stored on the RFID tag using the validation information. For example, with reference to FIG. 2, in some embodiments, command module 210 works in concert with security module 212 to store the validation information in security data 216. When the RFID tag transitions to a locked state, either some or all of the data stored in memory 206 can be gated by security module 212. In other words, security module 212 can grant or deny query commands for information depending upon whether the query commands include the appropriate validation information.

Upon locking the RFID tag, the retail computing device forwards the validation information to a user address at step 312. Recall that some embodiments of the retail computing device display a user interface notifying when the validation has been received from the backend server. Some aspects of the user interface can additionally include an input control in which to enter a user address, such as a mobile phone number, an email address, a street address, and so forth. In other embodiments, the user address may entail an address obtained by the retail computing device establishing a Bluetooth connection with the user computing device. Regardless of how the user address is obtained, after the user address is obtained, the retail computing device transmits the validation information to the user address, such as by email, by SMS text message, over a Bluetooth connection, and so forth. The retail computing device can alternately or additionally send information extracted from the RFID tag with the validation information, such as a serial number of the RFID tag. These varying combinations of information and/or data can be sent in one message, or multiple message. Thus, to complete a purchase transaction from the perspective of the retail computing device, the retail computing device forwards the validation information to the user address to effectively transfer ownership from the retailer to the user.

At step 314 and responsive to the purchase transaction, the user computing device retrieves the validation information. Here, the user has given the retail computing device user address information to use as part of the purchase transaction in order to gain access to the RFID tag. The user computing device may retrieve the validation information in any suitable manner, such as by accessing a user e-mail account to retrieve, scan, and/or display an email message (sent by the retail computing device) that includes the validation information. As another example, the user computing device may automatically identify when an incoming text message includes the validation information, and then extract the validation information (such as by way of client tag manager module 124 of FIG. 1). Alternately or additionally, some embodiments invoke the client tag manager module after receiving an input command to, and display a user interface that allows a user to enter the validation information in an input control.

At step 316a, the user computing device, by way of an RFID reader, accesses the RFID tag. For example, the user computing device can include an RFID reader, such as computing device 120 and RFID reader 122 of FIG. 1, or be communicatively coupled with an RFID reader. When the user computing device and/or the RFID reader moves within working range of the RFID tag (e.g., the RFID tag moves within range of the RFID tag, the RFID reader moves within range of the RFID tag, or both), the RFID reader detects the presence of the RFID tag as further described herein. To access the RFID tag, some embodiments of a client tag manager module display a user interface with various interactive controls that allow a user to configure or send commands to the RFID tag. The user interface can either be manually invoked by a user, and/or automatically displayed in response to the RFID reader detecting the presence of the RFID tag. Upon activation of various interactive controls are activated and/or input is received via the user interface, the user computing device, by way of the corresponding RFID reader, sends commands to the RFID tag over a wireless communication signal to access the RFID tag. In some embodiments, the commands include validation information used by RFID tag to authenticate access. In turn, at step 316b, the RFID tag allows access to the RFID tag based upon the validation information, such as through the use of command module 210 and security module 212 of FIG. 2 as further described herein.

The user interface of the client tag manager module enables a user to customize and control access to the RFID tag. For example, some embodiments allow a user to change access to the RFID tag by changing the validation information used to authenticate access to the RFID tag. First, the user interface may first request the validation information (obtained from the backend server) that was used to initially lock access to the RFID tag in order to authenticate the user has the necessary credentials to make this change. In turn, the request/command can be validated by the RFID tag as further described herein. Upon verifying the user has entered the proper validation information, the user interface may then display control options that enable the user to enter new and/or the validation information, such as changing a passcode or password. In turn, the user computing device, by way of the RFID reader, sends commands to the RFID tag that update the security data stored on the RFID tag, and change the access authentication information.

Other times, the user interface can display information stored local to the RFID tag (e.g., tag data 214 and/or security data 216 of FIG. 2), such as addresses to services provided by a manufacturer or user data captured by sensors. The user interface can also display various commands that can be sent to the RFID tag, thus allowing user customization of the RFID tag. In this manner, the user becomes associated with the RFID tag in that the user has access to the RFID tag as well as control over how the RFID tag is configured. This provides the user with extra security when purchasing a product that has a corresponding RFID tag attached to it.

Sometimes, upon accessing an RFID tag, the user computing device can become a trusted device to the RFID tag. For example, to initially access the RFID tag, the user computing device may first use the validation information received by the retail computing device as further described herein to validate access to the RFID tag. Upon gaining access to the RFID tag, the user computing device and the RFID tag establish trust such that subsequent access commands delivered from the user computing device are trusted by the RFID tag, and do not require the validation information. This can be achieved in any suitable manner, such as by an identification code included in each command that corresponds to the user computing device, commands being sent on a preassigned or predetermined communication channel dedicated to the user computing device, and so forth. Accordingly, some embodiments establish trusted access between the user computing device and the RFID tag. In such a scenario, the RFID tag gates access to untrusted computing devices such that access is only granted by way of the validation information. Conversely, for trusted devices (e.g., the user computing device), the RFID tag opens access to stored information without requiring validation information to gain access.

In some embodiments, the RFID tag can be unlocked and/or dis-associated with a user. Consider an example in which the user has purchased an item with an associated RFID tag. During the purchase transaction, a retail computing device has transferred ownership of the RFID tag to the user by locking the RFID tag and supplying the user with validation information as further described herein. However, at some point later in time, the user decides they no longer wish to own the item, and returns the item back to the retailer. As part of the return process, the retail computing device may attempt to access the associated RFID tag in order to modify the tag configuration back to a corresponding retail setting. In other words, the retail computing device attempts to remove the protected access (via the validation information) that was applied during the purchase transaction and/or reset the information stored on the RFID tag (e.g., remove any information added by the user, update or reset stored information to retailer information). Assuming the user has not changed the validation information used to access the RFID tag, the retail computing device can access the RFID tag using the validation information acquired during the purchase transaction and/or by querying the backend server for the validation information. However, if the user has changed the information to access the RFID tag, the retail computing device may be denied access to the RFID tag. In turn, some embodiments display a message indicating that access has been denied and further notify the user and/or the retail computing device to reset the access code and/or reset the validation information. Resetting the validation information can include the user providing the current RFID tag access information to the retailing computing device and/or the retail computing device querying the backend server for a reset command and/or passcode used to reset the RFID tag. Thus, some embodiments provide an ability to dis-associate an RFID tag from a user.

Having described an example method of RFID tag association to a user, consider now a discussion of example devices in which various embodiments can be implemented.

Example Devices

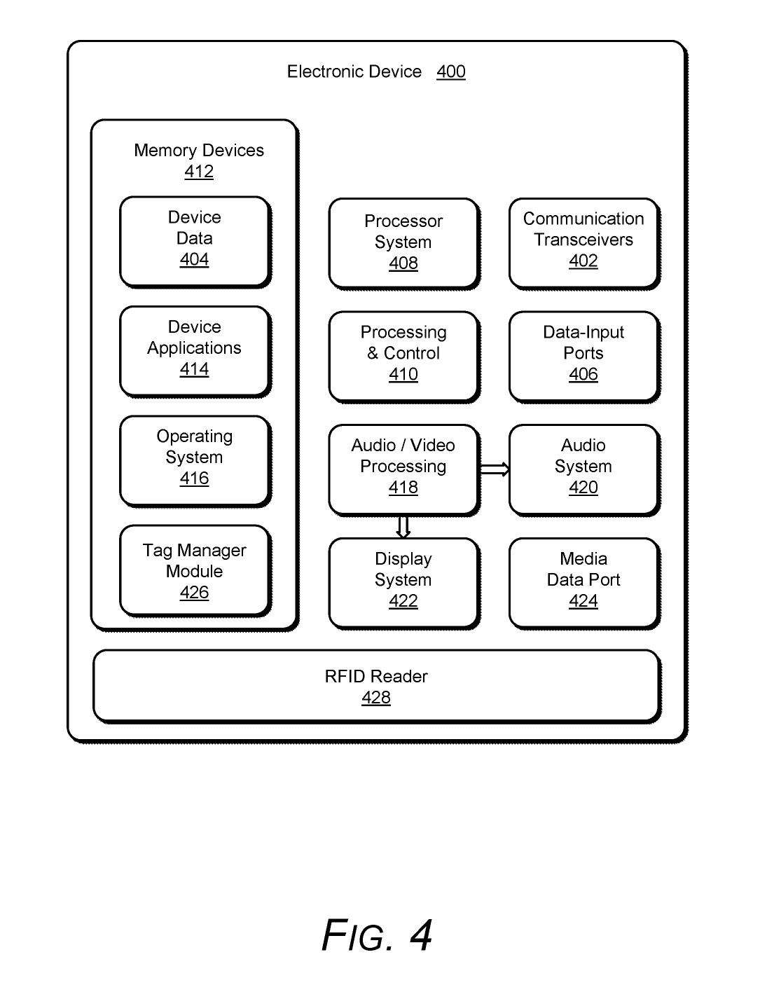

FIG. 4 illustrates various components of an electronic device 400 of which can be utilized to implement the embodiments described herein, such as computing device 106 or computing device 120 of FIG. 1. Electronic device 400 can be, or include, many different types of devices capable of implementing RFID tag association with a user in accordance with one or more embodiments.

Electronic device 400 includes communication transceivers 402 that enable wired or wireless communication of device data 404, such as received data and transmitted data. While referred to as a transceiver, it is to be appreciated that communication transceivers 402 can additionally include separate transmit antennas and receive antennas without departing from the scope of the claimed subject matter. Example communication transceivers include Wireless Personal Area Network (WPAN) radios compliant with various Institute of Electrical and Electronics Engineers (IEEE) 802.15 (Bluetooth™) standards, Wireless Local Area Network (WLAN) radios compliant with any of the various IEEE 802.11 (WiFi™) standards, Wireless Wide Area Network (WWAN) radios for cellular telephony (3GPP-compliant), wireless metropolitan area network radios compliant with various IEEE 802.16 (WiMAX™) standards, and wired Local Area Network (LAN) Ethernet transceivers.

Electronic device 400 may also include one or more data-input ports 406 via which any type of data, media content, and inputs can be received, such as user-selectable inputs, messages, music, television content, recorded video content, and any other type of audio, video, or image data received from any content or data source. Data-input ports 406 may include Universal Serial Bus (USB) ports, coaxial-cable ports, and other serial or parallel connectors (including internal connectors) for flash memory, Digital Versatile Discs (DVDs), Compact Disks (CDs), and the like. These data-input ports may be used to couple the electronic device to components, peripherals, or accessories such as keyboards, microphones, or cameras.

Electronic device 400 of this example includes processor system 408 (e.g., any of application processors, microprocessors, digital-signal processors, controllers, and the like) or a processor and memory system (e.g., implemented in a system-on-chip), which processes computer-executable instructions to control operation of the device. A processing system may be implemented at least partially in hardware, which can include components of an integrated circuit or on-chip system, digital-signal processor, application-specific integrated circuit, field-programmable gate array, a complex programmable logic device, and other implementations in silicon and other hardware. Alternatively, or in addition, the electronic device can be implemented with any one or combination of software, hardware, firmware, or fixed-logic circuitry that is implemented in connection with processing and control circuits, which are generally identified as processing and control 410. Although not shown, electronic device 400 can include a system bus, crossbar, interlink, or data-transfer system that couples the various components within the device. A system bus can include any one or combination of different bus structures, such as a memory bus or memory controller, data protocol/format converter, a peripheral bus, a universal serial bus, a processor bus, or local bus that utilizes any of a variety of bus architectures.

Electronic device 400 also includes one or more memory devices 412 that enable data storage, examples of which include random access memory (RAM), non-volatile memory (e.g., read-only memory (ROM), flash memory, EPROM, EEPROM, etc.), and a disk storage device. Memory devices 412 are implemented at least in part as a physical device that stores information (e.g., digital or analog values) in storage media, which does not include propagating signals or waveforms. The storage media may be implemented as any suitable types of media such as electronic, magnetic, optic, mechanical, quantum, atomic, and so on. Memory devices 412 provide data storage mechanisms to store the device data 404, other types of information or data, and various device applications 414 (e.g., software applications). For example, operating system 416 can be maintained as software instructions within memory devices 412 and executed by processor system 408.

Electronic device 400 also includes audio and video processing system 418 that processes audio data and passes through the audio and video data to audio system 420 and to display system 422. Audio system 420 and display system 422 may include any modules that process, display, or otherwise render audio, video, display, or image data. Display data and audio signals can be communicated to an audio component and to a display component via a radio-frequency link, S-video link, HDMI, composite-video link, component-video link, digital video interface, analog-audio connection, or other similar communication link, such as media-data port 424. In some implementations, audio system 420 and display system 422 are external components to electronic device 400. Alternatively, or additionally, display system 422 can be an integrated component of the example electronic device, such as part of an integrated display and touch interface.

In some aspects, memory devices 412 includes tag manager module 426, which manages access and/or communications with an RFID tag. For example, when implemented as a retail tag manager module, such as retail tag manager module 110 of FIG. 1, tag manager module 426 handles communications between a backend server, an RFID tag, and/or user computing device to retrieve validation information, lock down access to the RFID tag and/or associate the RFID tag with a user account effective to transfer ownership of the RFID tag. When implemented as a client tag manager module, such as client tag manager module 124 of FIG. 1, tag manager module 426 provides a user with access to the RFID tag by way of validation information and allows the user to customize or configure the RFID tag. While illustrated here as residing on memory devices 412, other embodiments of tag manager module 426 can utilize varying combinations of hardware, firmware, and/or software. To facilitate communications with an RFID tag, some embodiments of tag manager module 426 interface with RFID reader 428.

Electronic device 400 includes RFID reader 428, which represents functionality that extracts information from an RFID tag using wireless communication signals. Alternately or additionally, RFID reader 428 sends commands to the RFID tag via the wireless communication signals. While implemented as a component of 400, alternate embodiments of electronic device 400 utilize RFID reader 428 as an auxiliary device and/or a device that is communicatively coupled to electronic device 400.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A computing device comprising:
one or more processors; and
one or more computer-readable storage devices comprising processor-executable instructions which, responsive to execution by the one or more processors, enable the computing device to perform operations comprising:
detecting, as part of a purchase transaction and using a Radio Frequency IDentification (RFID) reader, a presence of an RFID tag associated with a product to be purchased;
extracting, using the RFID reader, data from the RFID tag;
requesting, from a server associated with the product and using at least some of the data from the RFID tag, validation information as part of the purchase transaction;
receiving, from the server, the validation information;
locking, using the RFID reader, the RFID tag based, at least in part, on the validation information; and
forwarding the validation information to a user address effective to transfer ownership of the RFID tag and complete the purchase transaction.

2. The computing device of claim 1, wherein the user address comprises a mobile phone number, and
wherein forwarding the validation information further comprises sending the validation information over a Short Message Service (SMS) text message to the phone number.

3. The computing device of claim 1, wherein requesting the validation information further comprises:
extracting product information from the data; and
forwarding the product information to the server when requesting the validation information.

4. The computing device of claim 1, wherein receiving the validation information further comprises receiving a passcode or a password from the server.

5. The computing device of claim 1, wherein locking the RFID tag further comprises:
sending, to the RFID tag and using the RFID reader, a command to gate access to data stored on the RFID reader based on the validation information.

6. The computing device of claim 5, wherein sending the command to gate access further comprises:
displaying, on a display device of the computing device, a user interface comprising an interactive control;
receiving input associated with activation of the interactive control; and
responsive to receiving the input associated with activation of the interactive control, sending the command to gate access.

7. The computing device of claim 1, wherein forwarding the validation information further comprises:
displaying a user interface on a display device associated with the computing device, wherein the user interface comprises at least one input control;
receiving, via the at least one input control, the user address; and
transmitting the validation information to the user address over a communication network.

8. The computing device of claim 1, wherein requesting the validation information from the server further comprises:
extracting, from the data from the RFID tag, a communication address associated with the server; and
generating a request for the validation information; and
transmitting the request to the communication address over a communication network.

9. A computing device comprising:
a Radio Frequency Identification (RFID) reader;
one or more processors; and
one or more computer-readable storage devices comprising processor-executable instructions which, responsive to execution by the one or more processors, enable the computing device to perform operations comprising:
retrieving, responsive to a purchase transaction associated with a product, validation information associated with transferring ownership of an RFID tag associated with the product from a retail computing device to a user account associated with the computing device;
detecting the RFID tag using the RFID reader;
responsive to detecting the RFID tag, displaying a user interface associated with accessing the RFID tag; and
responsive to receiving input via the user interface, accessing, using the RFID reader, the RFID tag to transfer the ownership of the RFID tag from a retail computing device associated with the purchase transaction to a user account associated with the computing device.

10. The computing device as recited in claim 9, wherein the computing device comprises a mobile phone.

11. The computing device as recited in claim 9, wherein the accessing the RFID tag further comprises:
sending, using the RFID reader, one or more data packets comprising:
a command to access data stored on the RFID tag; and
at least some of the validation information.

12. The computing device as recited in claim 9, the operations further comprising:
validating, using the RFID reader, access to the RFID tag;
receiving, via the user interface, input associated with changing access to the RFID tag; and
sending, using the RFID reader, one or more commands to the RFID tag to update security data stored on the RFID tag.

13. The computing device as recited in claim 9, wherein accessing the RFID tag further comprises establishing trusted access to the RFID tag.

14. The computing device as recited in claim 9, wherein retrieving validation information further comprises retrieving the validation information from an electronic mail account.

15. The computing device as recited in claim 9, wherein accessing the RFID tag further comprises:
sending, using the RFID reader, a kill command to permanently disable access to the RFID tag.

16. The computing device as recited in claim 9, the operations further comprising:
retrieving, using the RFID reader, product information stored on the RFID tag based, at least in part, on the validation information; and
displaying at least some of the product information in the user interface.

17. A computer-implemented method comprising:
detecting, using a Radio Frequency IDentification (RFID) reader associated with a retail computing device, a presence of an RFID tag associated with a product to facilitate a purchase transaction;
extracting, using the RFID reader, data from the RFID tag;
requesting, using the retail computing device, validation information from a server associated with the product by:
extracting an address to the server from the data; and
sending a request to the address;
receiving, at the retail computing device and from the server, the validation information;
locking, using the RFID reader, the RFID tag based, at least in part, on the validation information;
receiving, at the retail computing device, a user address; and
forwarding, using the retail computing device, the validation information to the user address over a communication network effective to transfer ownership of the RFID tag from the retail computing device to the user address and complete the purchase transaction of the product.

18. The computer-implemented method as recited in claim 17, wherein forwarding the validation information comprises:
sending the validation information in an electronic mail (email) to the user address when the user address comprises an email address; and
sending the validation information in a text message when the user address comprises a mobile phone number.

19. The computer-implemented method as recited in claim 17, wherein requesting validation information from the server further comprises:
extracting product information or manufacturing information from the data; and
sending the product information or the manufacturing information to the server.

20. The computer-implemented method as recited in claim 17, further comprising:
displaying, at the retail computing device, a user interface when the RFID tag is detected, the user interface comprising an interactive control associated with requesting validation information;
sending a request for validation information to the server in responsive to activation of the interactive control.
